(19) United States
(12) Patent Application Publication
(10) Pub. No.: US 2010/0263549 A1
(43) Pub. Date: Oct. 21, 2010

(54) TEA AND HERB INFUSING BEVERAGE CONTAINER

(75) Inventor: Theresa H. Lee, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: CHEF'N CORPORATION, Seattle, WA (US)

(21) Appl. No.: 12/726,280

(22) Filed: Mar. 17, 2010

Related U.S. Application Data
(60) Provisional application No. 61/161,963, filed on Mar. 20, 2009.

(51) Int. Cl. A47J 31/20

(52) U.S. Cl. 99/319

(57) ABSTRACT

An infusing apparatus or beverage container includes a container, a perforated infusion element configured to be positioned in the container, and an actuator including an activating member and an actuator body. The activating member is accessible from outside the interior space and rotatably coupled with respect to the container, and the actuator body is rotatably coupled to the infusion element, such that rotation of the actuator body with respect to the container can lower and raise the infusion element with respect to the container to selectively begin and cease an infusion process and drink the resulting beverage without having to remove herbs or tea placed in the infusion element.

### CROSS-REFERENCE TO RELATED APPLICATION

This application claims the benefit under 35 U.S.C. §119(e) of U.S. Provisional Patent Application No. 61/161,963 filed Mar. 20, 2009, where this provisional application is incorporated herein by reference in its entirety.

### BACKGROUND

1. Technical Field

The present disclosure is generally related to beverage containers, and more particularly, to a beverage container with an integrated tea and/or herb infusing apparatus.

2. Description of the Related Art

Modern-day lifestyles are increasingly mobile, especially in urban communities. Individuals are often on the go regardless of financial status, marital status, gender, and parental status. Since such individuals are typically stretched for time, they typically accomplish certain tasks while they are en route between activities, errands and avocations and/or while they are attending to their activities, errands and/or avocations. This trend has led to products designed to suit such lifestyles.

In particular, beverages, such as coffee and tea are often consumed on the go. For example, often individuals either buy or make their beverages to take with them so they can consume their beverage wherever, for example, in a vehicle, in a meeting, during sports activities, or any other place where traditional beverage containers are not suitable due to the user being in motion or having limited capabilities to handle and/or manipulate the beverage container. This trend has also led to the rise of coffee bars and tea houses. Furthermore, individuals are increasingly drinking tea and herbal tea in addition to or instead of coffee. Tea is generally not brewed in large amounts, as is the case with coffee. Therefore, brewing and infusing tea is time-consuming and often requires more than one container or device. For example, the tea can be brewed in a teakettle and then poured into a mug for drinking.

A common conventional solution for expediting the tea brewing process is tea bags. However, tea bags typically include shredded tea leaves, which lack the quality that is obtained when large whole dried leaves are used. Pyramid shaped teabags have surfaced on the market that have the volume to hold larger leaves; however, these teabags are very expensive and therefore they are not efficient for frequent tea drinking. Furthermore, tea bags need to be disposed after infusion, which is inconvenient when the user is driving, in a meeting or in any other situation or location where the tea bag cannot be conveniently disposed. Other conventional products include portable infusers with a handle, allowing tea leaves to be placed in a perforated housing, which is then dipped in a mug with hot water.

However, this still requires more than one product to handle and the lid of the mug generally has to be removed during the infusing process, impeding optimal infusing of the tea. Since these conventional infusers need to be removed from the cup or mug in which tea or other herbs are infused, the do not resolve the inconvenience problems associated with tea bags.

### BRIEF DESCRIPTION OF THE SEVERAL VIEWS OF THE DRAWINGS

FIG. 1 is an isometric view of an integrated infusing apparatus according to one embodiment.

FIG. 2 is a top plan view of the integrated infusing apparatus of FIG. 1 according to one aspect.

FIG. 3 is a cross-sectional view of the integrated infusing apparatus of FIG. 2 with a liquid therein, viewed across section 3-3, illustrating an infusion assembly of the apparatus in a first state, according to one aspect.

FIG. 4 is an isometric view of an actuator of the integrated infusing apparatus of FIG. 1 according to one aspect.

FIG. 5 is a cross-sectional view of the integrated infusing apparatus of FIG. 2 with a liquid therein, viewed across section 5-5, illustrating the infusion assembly in a second state, according to one aspect.

FIG. 6 is a partial cross-sectional view of the integrated infusing apparatus of FIG. 2, viewed across section 6-6, illustrating the infusion assembly in the first state, according to one aspect.

FIG. 7 is a partial cross-sectional view of the integrated infusing apparatus of FIG. 2, viewed across section 7-7, illustrating the infusion assembly in the second state, according to one aspect.

FIG. 8 is an isometric view of an infusion element of an integrated infusing apparatus according to one embodiment.

FIG. 9 is an isometric view, transparently illustrating an actuator of an integrated infusing apparatus according to one embodiment.

FIG. 10 is an isometric view, illustrating the infusion element of FIG. 8 coupled to the actuator of FIG. 9, which is transparently illustrated.

FIG. 11 is an exploded isometric view of an integrated infusing apparatus according to one embodiment.

FIG. 12 is a bottom plan view of an integrated infusing apparatus according to one embodiment.

FIG. 13 is a side view of an integrated infusing apparatus according to another embodiment.

### DETAILED DESCRIPTION

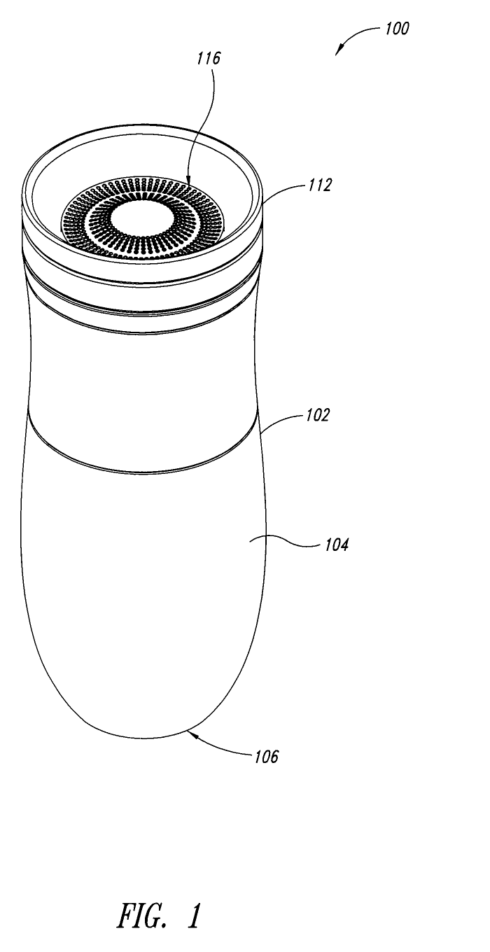

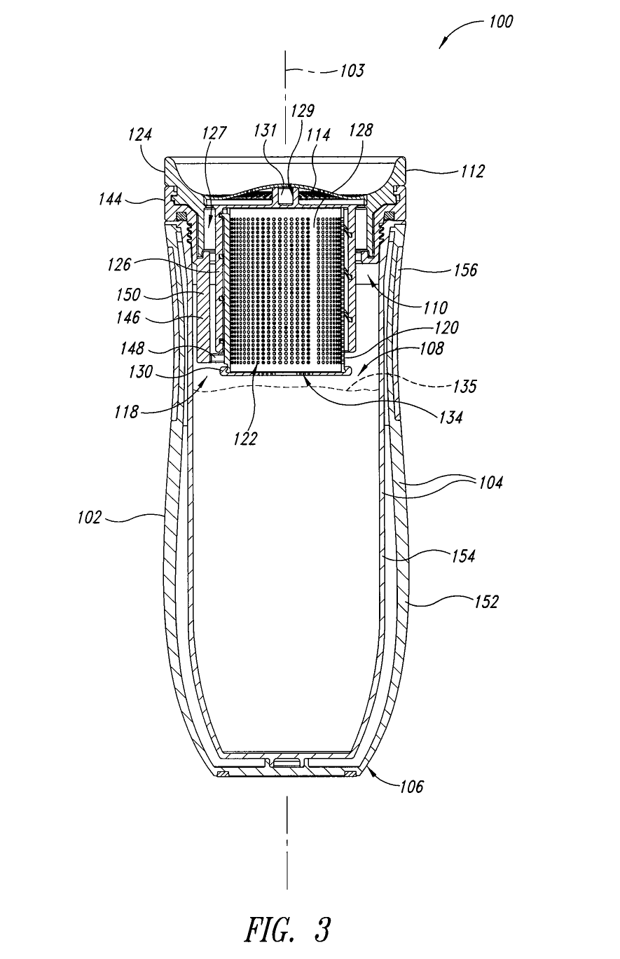

FIG. 1 illustrates an integrated infusing apparatus 100 according to one embodiment. The infusing apparatus 100 includes a beverage container 102 having a body 104 and a base 106, together forming an interior space 108 (FIG. 3) configured to receive, store and dispense liquids. The interior space 108 can have any suitable shape. In the illustrated embodiment of FIG. 3, the interior space 108 and the beverage container 102 are elongated along a direction of a central axis 103. The beverage container 102 includes an opening 110 toward an end thereof opposite the base 106. The infusing apparatus 100 further includes an actuator 112 rotatably coupled to the beverage container 102. In one embodiment, the actuator 112 is rotatably coupled to the beverage container 102 toward the opening 110. The infusing apparatus 100 can also include a lid or cap member 114 having a plurality of openings 116 (FIG. 1) that allow fluid to be dispensed from the interior space 108.

As illustrated in FIG. 3, the infusing apparatus 100 includes a selective infusion assembly 118 that is configured to allow a user to selectively infuse a desired item such as an herb or a plant, for example various forms of tea, for any desired duration, and cease infusion without the need to remove the infusion assembly 118 or the infused contents from the container. For the sake of convenience and clarity of description, infusion throughout this application will be primarily used in the context of tea infusion, without any intention to limit the scope of the present disclosure and/or the claims that follow to a particular application.

In contrast to conventional infusers or beverage containers, the infusing apparatus 100 allows a user to initiate tea infusion in the inner space 108 of the beverage container 102, continue the infusion for any desired duration, stop the infusion process, and enjoy the resulting infused beverage without having to remove from the container any portion of the infusion assembly 118 or the infused tea therein.

In one embodiment, the selective infusion assembly 118 includes the actuator 112 and an infusion element 120. The infusion element 120 includes a plurality of perforations, apertures and/or openings 122 that allow hot water in the interior space 108 permeate through the infusion element 120 and infuse tea leaves positioned therein. In one aspect, the actuator 112 is coupled with respect to the infusion element 120 such that when the actuator 112 is rotated, the infusion element 120 moves longitudinally with respect to the container 102. Accordingly, the actuator 112 and infusion element 120 are directly or indirectly coupled to convert activation of the actuator 112 to movement of the infusion element 120 in the interior space 108.

All suitable coupling arrangement between the actuator 112 and the infusion element 120 that facilitate selective infusion of contents in the infusion element 120 by activation of an accessible actuator 112, or a portion thereof, to move the infusion element 120, are contemplated to be within the scope of the present disclosure and the claims that follow. The following provides a description of one embodiment, in which when the actuator 112 is rotated in a first direction, the infusion element 120 moves toward the base 106 of the beverage container 102, and when the actuator is rotated in a second direction, the infusion element 120 moves toward the opening 110 of the beverage container 102.

Accordingly, when hot water is poured in the interior space 108 of the beverage container 102 and tea leaves are placed in the infusion element 120, the user can activate the actuator 112 to lower the infusion element 120 into the hot water, and after a desired duration, reactivate the actuator 112 to raise the infusion element 120 out of the hot water, terminating the infusion process.

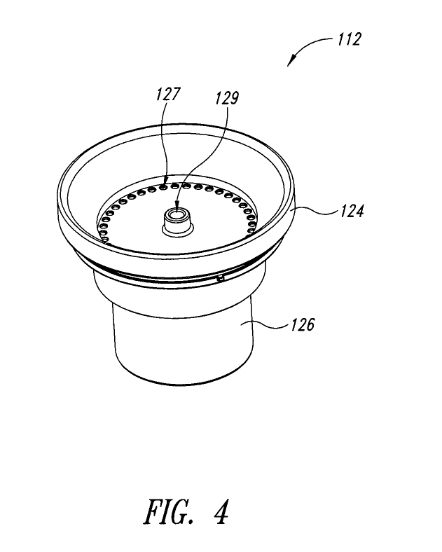

In one embodiment, as illustrated in FIG. 4, the actuator 112 includes an activating member 124 fixedly coupled to an actuator body 126. The activating member 124 and actuator body 126 can be fabricated from a unitary body of material. As illustrated in FIG. 3, the activating member 124 can be rotatably coupled with respect to the body 104 of the beverage container 102 toward the opening 110. At least a portion of the actuator body 126 can extend through the opening 110 into the interior space 108 of the beverage container 102. In one aspect, the actuator 112 includes at least one or a plurality of openings 127 in fluid communication with the interior space 108 to facilitate dispensing and/or drinking of liquid from the beverage container 102.

The actuator 112 and lid member 114 may include a first engagement feature 129 and a complementary second engagement feature 131, respectively, which facilitate removably coupling the lid member 114 to the actuator 112. In the illustrated embodiment of FIG. 3, the first engagement feature 129 includes a blind aperture, and the second engagement feature 131 includes a protrusion configured to be captively received in and engage the blind aperture. The phrases “blind aperture” and “protrusion” are used here for clarity of description and convenience, without any intention to limit the scope of the structure, shape and/or configuration of the first and second engagement features 129, 131. The lid member 114 can be optional and is discussed further below in more detail.

In one aspect, the infusion element 120 is moveably coupled to the actuator body 126 such that rotation of the activating member 124 moves the infusion element 120, for example, in a direction parallel to the first axis 103 of the beverage container 102.

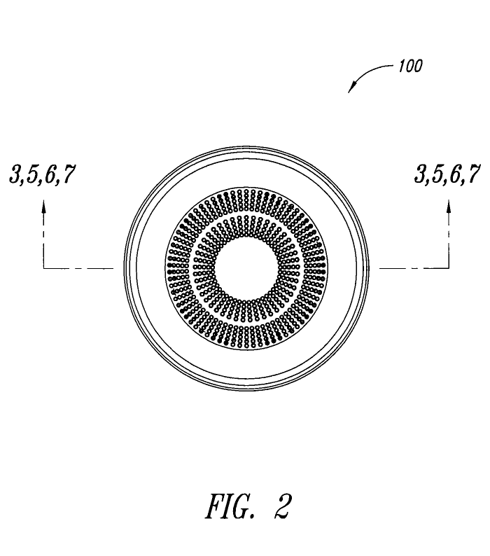

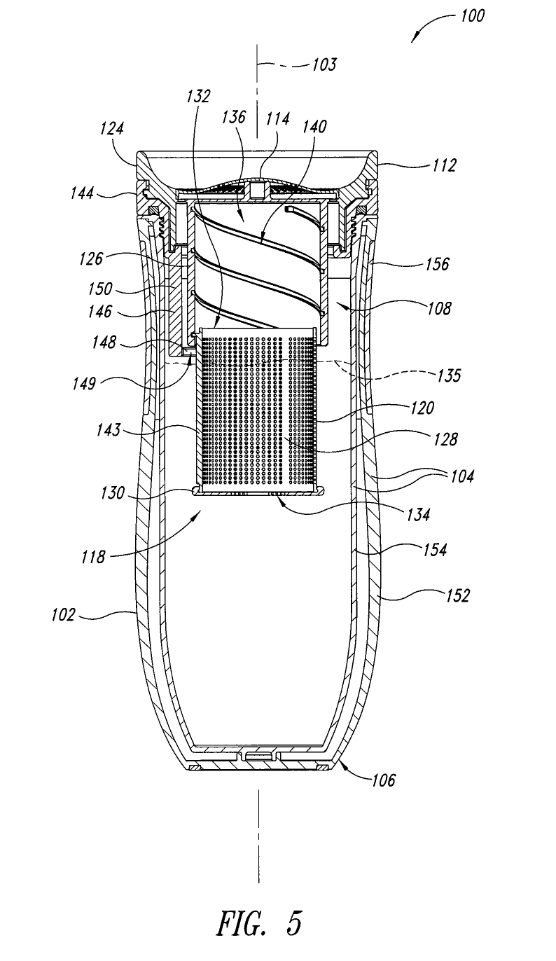

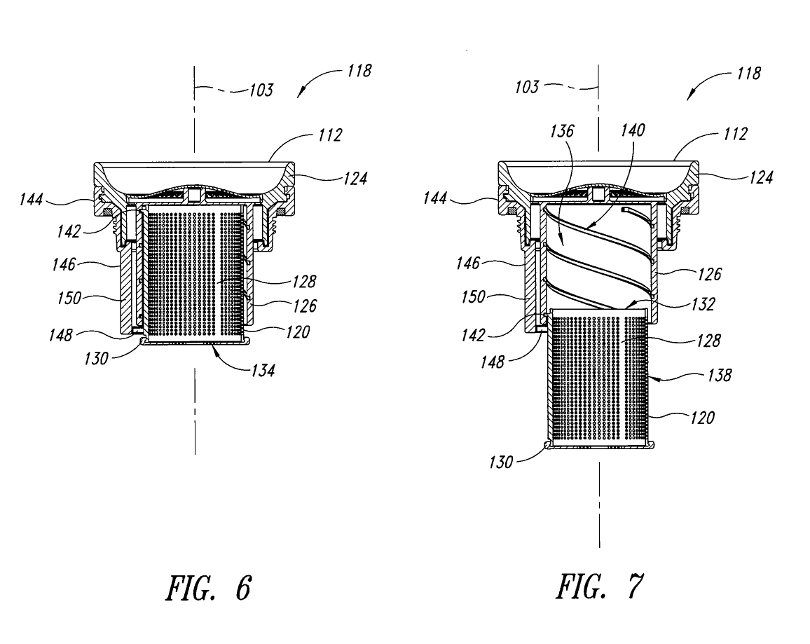

FIGS. 3, 5, 6 and 7 are cross-sectional views of the infusion assembly 118 in a taken along a section as shown in FIG. 2. FIGS. 3 and 6 illustrate the infusion assembly 118 in a first state in which the infusion element 120 is raised and FIGS. 5 and 7 illustrates the infusion assembly 118 in a second state in which the infusion element 120 is lowered. The terms “raised” and “lowered” are used here for clarity of description and convenience to respectively refer to the first and second states in which the infusion element 120 is moved away from and toward liquid, such as hot water, in the interior space 108 when the infusion assembly 118 is coupled to the beverage container 102, in which the liquid is poured. The terms “raised” and “lowered” are used without any intention to limit the direction or directions along which the infusion element 120 can move in different embodiments.

Referring to FIGS. 6 and 7, in one embodiment, the infusion element 120 includes an infuser body 128 and an infuser cap 130 that is removably coupled to the infusion element 120. For example, in the illustrated embodiment of FIGS. 6 and 7, the infuser body 120 is a hollow cylinder, and in one aspect, elongated along the direction of the central axis 103. The infusion element 120 includes a first end 132 and a second end 134.

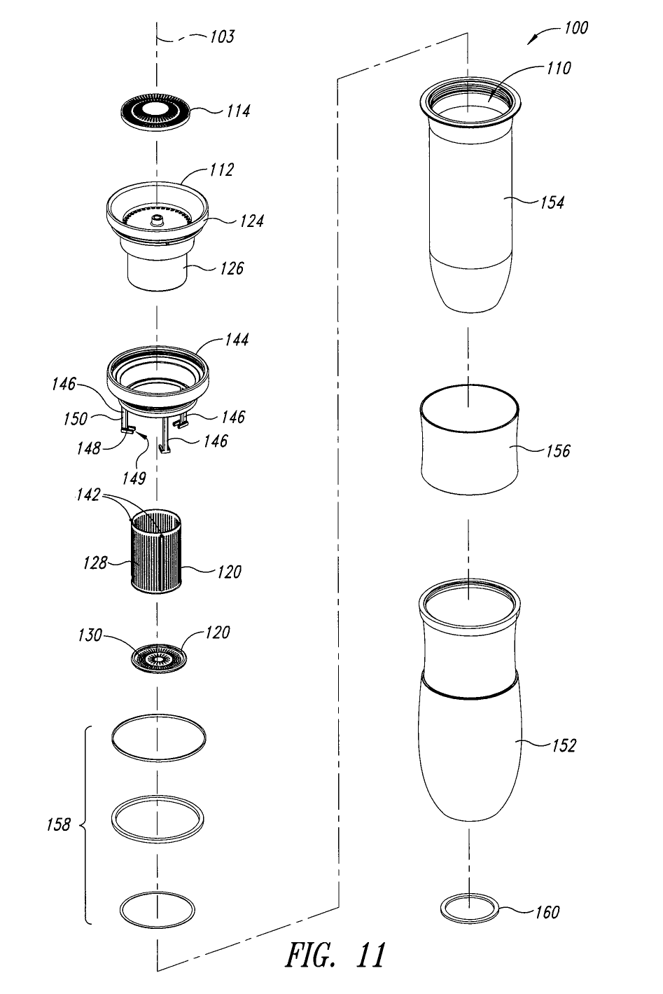

The infuser cap 130 can be any suitable shape. In the illustrated embodiment of FIGS. 6 and 7, the infuser cap 130 is substantially circular (FIG. 11) and is removably coupled to the infuser body 128 toward the second end 134 of the infusion element 120. The infuser cap 130 can be removably coupled to the infuser body 128 via a coupling feature or features that facilitate removal and coupling thereof from and to the infuser body 128, respectively. For example, the infuser body 128 and infuser cap 130 can have complementary structural features, such as a protrusion and a recess, respectively, which allow a user to easily snap the infuser cap 130 off of and onto the infuser body 128. In another embodiment, the infuser cap 130 can be pivotably coupled to the infuser body 128. In one embodiment, the infuser cap 130 includes a plurality of perforations, slits, apertures, or openings, further facilitating the infusion process during use.

In one embodiment, the actuator body 126 can include a hollow cylindrical shape, and in one aspect, elongated in the direction of the first axis 103. The actuator body 126 can include an inner surface 136 that has a diameter larger than a diameter of an outer surface 138 of the infusion element 120 and/or the infuser body 128 thereof.

The actuator body 126 includes a first coupling feature 140, which in one embodiment can be formed on or in the inner surface 136 of the actuator body 126, or coupled or attached thereto. In one aspect, the actuator body 126 and the first coupling feature 140 are formed from, or make up, a unitary body. The infusion element 120 includes a second coupling feature 142, which in one embodiment can be formed on or in the outer surface 138 of the infusion element 120, or coupled or attached thereto. In one aspect, the infusion element 120 and the second coupling feature 142 are formed from, or make up, a unitary body.

The first coupling feature 140 is configured to be engaged with the second coupling feature 142 to allow a movement of the actuator body 126 to be converted into a movement of the infusion element 120. In one embodiment, the coupling features 140, 142 are configured to convert rotation of the actuator body 126 about the first axis 103 to axial movement of the infusion element 120 along the direction of the first axis 103. Furthermore, the first and second coupling features 140, 142 can be configured such that the infusion element 120 moves in a first axial direction when the actuator body 126 is rotated in a first rotational direction, and the infusion element 120 moves in a second axial direction, opposite to the first axial direction, when the actuator body 126 is rotated in a second rotational direction, opposite to the first rotational direction.

For example, in the illustrated embodiment of FIGS. 6 and 7, the first coupling feature 140 includes at least one recess or groove formed in the inner surface 136 of the actuator body 126. For clarity of description and convenience, the first coupling feature 140 will be referred to as recess 140, without any intention to limit the scope of the structure, shape and/or configuration of the first coupling feature 140. Furthermore, in the illustrated embodiment of FIGS. 6 and 7, the second coupling feature 142 includes a tab, protrusion, shoulder or tongue, or any other suitable coupling feature configured to engage the recess 140 as described above. For clarity of description and convenience, the second coupling feature 142 will be referred to as tab 142, without any intention to limit the scope of the structure, shape and/or configuration of the first coupling feature 142. Furthermore, some embodiments may include a plurality of recesses 140 and tabs 142 for added stability and smoother movement of the infusion element 120, as described further below.

In one embodiment, the recess 140 extends along a spiral or helical path from a location toward a first axial end of the inner surface 136 of the actuator body 126, toward a location near an opposing second axial end of the inner surface 136. For clarity of description and convenience, the first and second ends of the inner surface 136 will be referred to as upper and lower ends, without any intention to limit the positioning and/or orientation of the terminating ends of the inner surface 136 and/or the helical recess 140.

As illustrated in FIG. 6, in the first state, the infusion element 120 is raised such that the tab 142 is engaging the recess 140 toward the upper end. When the activating member 124 of the actuator 112 is rotated, the actuator body 126 rotates therewith in the same direction because, as mentioned earlier, the activating member 124 is fixedly coupled to, or formed or fabricated from a unitary body of material with, the actuator body 126. Therefore, rotation of the activating member 124 and the actuator body 126 with respect to the infusion element 120 causes the tab 142 to travel along the helical recess 140 and axially move the infusion element 120. For example, when the infusion assembly 118 is coupled to the beverage container 102 (FIG. 3), and the activating member 124 is rotated in the first radial direction, the infusion element 120 moves toward the base 106 of the beverage container 102 as shown in the second state illustrated in FIGS. 5 and 7. In the second state, the tab 142 is engaging the recess 140 toward the lower end.

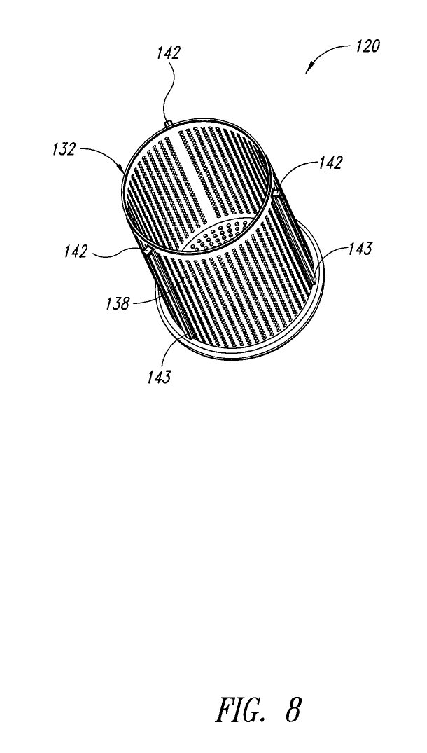

As discussed above, in some embodiments the inner surface 136 of the actuator body 126 can include more than one recess 140 and the infusion element 120 can include more than one tab 142. For example, FIG. 8 illustrates the infusion element 120 according to an embodiment in which the infusion element 120 includes three tabs 142 substantially equally spaced about the outer surface 138 of the infusion element 120. Each of the tabs 142 can be attached to, or formed from a unitary body of material with, an elongated support and guide member 143 that is fixedly attached to the outer surface 138. To maximize the range of movement of the infusion element 120, the second coupling feature 142 can be positioned toward the first end 132 of the infusion element 120.

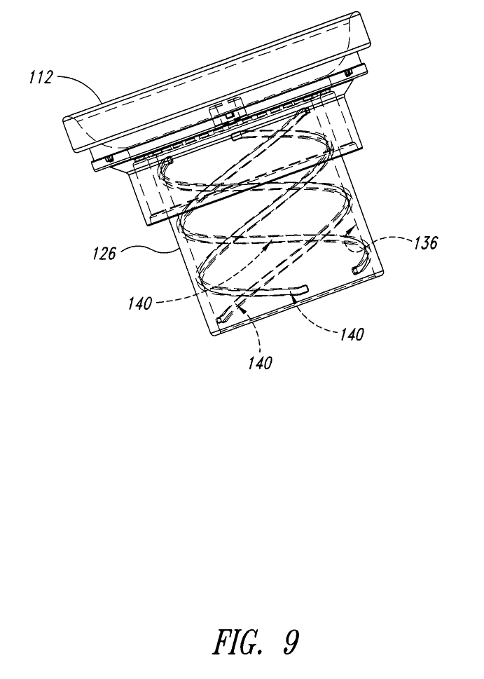

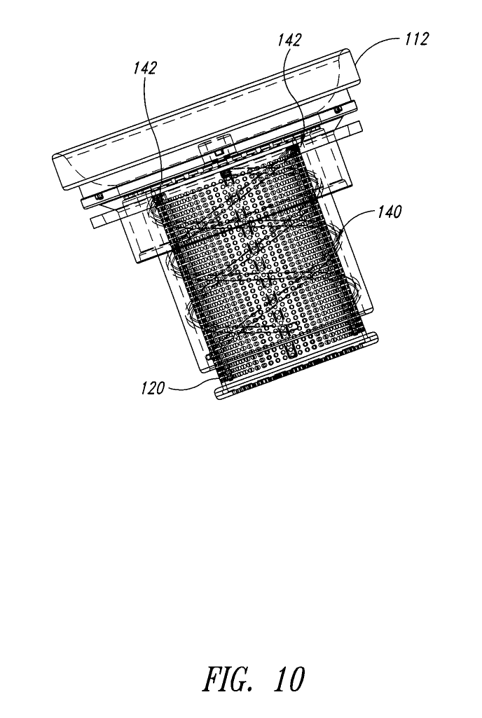

Furthermore, FIG. 9 is a broken line view of the actuator 112 according to one embodiment in which the actuator 112 includes three helical recesses 140 formed in the inner surface 136 of the actuator body 126. The three recesses 140 are configured to be slidably engaged or coupled to the three tabs of the infusion element 120 (FIG. 8), respectively. FIG. 10 illustrates the actuator 112 and infusion element 120 in the first raised state where the actuator 112 is transparently illustrated to reveal the slidable engagement between more than one recess 140 and more than one tab 142. Two of the tabs 142 can be seen in FIG. 10. The three tabs 142 balance the weight of the infusion element as they support the weight against the respective recesses 140, and therefore, can improve alignment and stability of the infusion element as it moves between the first and second states.

Referring to FIGS. 3 and 5, the user can remove the infuser cap 130 and place a desired amount of his or her choice of herbs and/or tea, or other item or items desired to be infused, in the infuser body 128 or infusion element 120. The infuser cap 130 is coupled to the infusion body 128 to retain the tea inside the infusion element 120. The beverage container 102 can be filled with hot water. For example, hot water can be poured in the inner space 108 to a level 135 such that, when the infusion assembly 118 is coupled to the beverage container 102, the water level 135 reaches up to or terminates below the lower end of the actuator body 126, or of the second end 134 of the infusion element 120 when the infusion assembly 118 is in the first state.

As illustrated in FIG. 3, the infusion assembly 118 with the tea placed therein can be coupled to the beverage container 102 toward the opening 110 thereof. When the infusion assembly 118 is coupled to the beverage container 102, the actuator 112 is rotatably coupled or mounted with respect to the beverage container 102, or the body 104 thereof. When the user desires to begin the infusion process, the user can selectively lower the infusion element 120 to at least partially submerge it in the hot water, or to an extent that all or some of the openings 122 thereof, are submerged in the hot water, as illustrated in FIG. 5.

To lower the infusion element 120 toward the second state illustrated in FIG. 5, the activation member 124 of the actuator 112 is rotated in the first direction to move the infusion element 120 toward the base 106 of the beverage container 102. After a desired time period, during which the infusion process continues, the user can rotate the activation member 124 in the second direction to move the infusion element 120 away from the base 106 and out of the hot water to cease the infusion.

In one embodiment, as illustrated in FIGS. 3 and 4, the opening or openings 127 in the actuator 112 can be positioned to fluidly communicate with a portion of the interior space 108 of the container 102 surrounding the infusion element 120 and or the actuator body 126, therefore, minimizing or eliminating any further routing of the tea beverage through the infusion element 120 as the user drinks the tea.

In embodiments that incorporate the lid member 114, the lid member 114 can be removably coupled to the actuator 112 on a surface of the actuator 112, opposing a surface adjacent or proximate to which the infusion element 120 is positioned. For example, in the illustrated embodiment of FIG. 3, the actuator 112 includes an upper surface exposed to a surrounding environment, in which the openings 127 are formed, and a lower surface opposing the upper surface and facing the infusion element 120. Furthermore, the blind aperture 129 is formed on the upper surface to captively receive the protrusion 131 of the lid member 114.

In some embodiments, the lid member 114 can be oriented with respect to the actuator 112 such that the openings 116 in the lid member 114 are not aligned with the openings 127 in the actuator 112, to minimize or eliminate liquid from splashing out of the beverage container 102 when the container it moved quickly. The lid member 114 and/or the actuator 112 with their respective openings 116, 127 also allow a beverage inside the beverage container 102 to breath and also provide an outlet for the tea aroma, which the user may enjoy while consuming the beverage. Although in the illustrated embodiment of FIG. 3, the openings 127 are positioned in a laterally extending portion or surface of the actuator 112, in other embodiments, the openings 127 can be positioned in a separate component coupled to the actuator 112.

As discussed further above, the actuator 112 can be directly or indirectly coupled toward the opening 110 of the beverage container 102, and configured to rotate with respect to the beverage container 102. In the illustrated embodiment of FIG. 3, the integrated infusing apparatus 100 and/or the infusion assembly 118, include an actuator coupling member 144, such as a coupling ring 144, configured to rotatably couple the actuator 112 to the beverage container 102. The phrase “coupling ring” is used here for clarity of description and convenience, without any intention to limit the scope of the structure, shape and/or configuration of the actuator coupling member 144.

The coupling ring 144 can be configured to be removably coupled to the beverage container 102, for example threadedly or via any other suitable coupling method or feature. Furthermore, the coupling ring 144 can include any feature that facilitates rotatably coupling the actuator 112 to the coupling ring 144. For example, as shown in FIG. 3, the coupling ring can include at least one receptacle and/or opening, for example an opening that is concentric about the central axis 103, which is configured to receive the actuator 112 such that the actuator 112 can be rotated with respect to the coupling ring 144. In the illustrated embodiment of FIG. 3 the coupling ring 144 includes threads on at least a portion of an outer surface of the coupling ring 144 that can be engaged with complementary threads formed on a portion of an interior surface of the beverage container 102, for example, toward or adjacent the opening 110 of the container 102. Other suitable coupling methods are contemplated to be within the scope of the present disclosure and the claims that follow.

Furthermore, in the illustrated embodiment of FIG. 3, an inner surface of the coupling ring 144 is positioned adjacent an outer surface of at least a portion of the activating member 124 and/or actuator body 126. However, one of ordinary skill in the art can appreciate that these components can be coupled in any suitable manner. For example, in some embodiments, the actuator 112 can have a cylindrical section extending from its outer lateral ends toward the base 106, and rotatably engaging the coupling ring 144, or a portion of an outer surface of the container 102.

In some embodiments, the integrated infusing device 100 and/or the infusion assembly 118 can include at least one, or more than one, alignment member 146, which is more clearly shown, for one aspect, in FIGS. 6 and 7. The alignment member 146 is positioned and configured to maintain alignment of the infusion element 120 with respect to the beverage container 102 and/or the actuator 112. For example, in embodiments in which the infusion element 120 includes a cylindrical body, such as the body 128 shown in FIGS. 6 and 7, the alignment member or members 146 can be configured to facilitate maintaining a central axis of the infusion element 120 aligned with the central axis 103 of the beverage container 102. The alignment member 146 also aids in maintaining the tabs 142 slidably coupled to the recesses 140 and prevents inadvertent disengagement of these features.

For example, the alignment member 146 or a portion thereof can be positioned adjacent at least a portion of the infusion element 120, and have at least one flange 148 that extends toward the infusion element 120, which contacts the infusion element 120 if it tends to move toward a misaligned position. The alignment member 146 can include a first end that is fixedly coupled to the coupling ring 144, and a second end toward which a flange 148 is formed or positioned. The terminal end of the flange 148 can end in a notch 149. The alignment member or members 146 and the coupling ring 144 can be formed or fabricated from a unitary body of material. For example, the exploded view of FIG. 11 shows one embodiment in which three alignment members 146 extend from the coupling ring 144. The terminal end of the flange 148 can end in a notch 149. The alignment members 146 can each include an elongated arm 150 between the first and second ends thereof, that extends adjacent the actuator body 126, to position the flange 148 adjacent or contiguous to a portion of the infusion element 120. The notch 149 in the flange 148 can captively receive the guide member 143 to prevent the infusion element 120 from rotating along with the actuator 112, thus forcing the tabs 142 to follow the helical recess 140 as the actuator is rotated with respect to the container 102.

Some embodiments may include fewer or additional features without departing from the scope of the present disclosure and the claims that follow. For example, as illustrated in FIGS. 3, 5 and 11, the beverage container 102 can include an outer shell 152 and an inner shell 154 coupled to the outer shell 152, or inserted therein. Having two shells improves insulation qualities of the container 102 and reduces heat dissipation from the beverage to maintain a hot or cold temperature for a longer duration. The components of the integrated infusing apparatus 100 can be fabricated from any suitable material. In embodiments having two shells the material of each shell can be selected to optimize its function.

For example, the inner shell 154 can be fabricated from a material more suitable to contain the beverage, such as plastic, ceramics, glass, acrylic, polycarbonate and/or polyester and/or alloys thereof such as those offered under the trademark ClearPC®, or other suitable material. The outer shell 152 can be fabricated from a material that optimizes insulation and/or appearance, such as metals, glass, ceramics, plastics, silicone, composites, acrylic, polycarbonate and/or polyester or alloys thereof such as those offered under the trademark ClearPC®, and/or any other suitable material.

Furthermore, in some embodiments, the integrated infusion apparatus 100 can include a grip member 156 coupled to and/or concentrically positioned about a portion of an outer surface of the container 102. The grip member 156 can be fabricated from a material with non-slip qualities that aids in gripping the apparatus 100, such as plastic, rubber, foam, and/or any other suitable material. In some embodiments at least one handle (not shown) can be incorporated to facilitate holding the apparatus 100. Furthermore, the container 102 can be shaped in any suitable manner, for example, it may have a base 106 that is configured to facilitate placing the container 102 in a cup or mug holder.

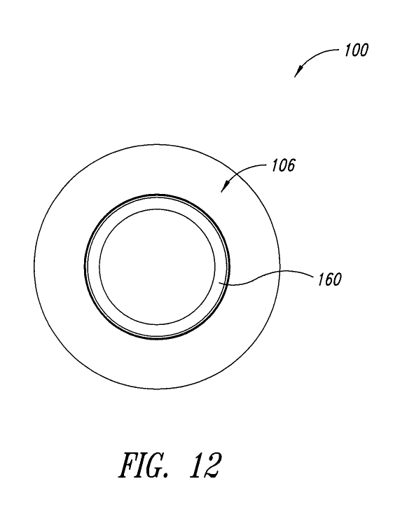

As illustrated in FIG. 11, some embodiments may incorporate one or more gaskets 158 that can be positioned between mating parts to prevent any leaks. For example, a gasket 158 can be positioned between the coupling ring 144 and the container 102. In one aspect, the integrated infusion apparatus 100 can also include a non-slip member 160 coupled or attached to a portion of the base 106 of the container 102, which supports the apparatus 100 on a surface, as illustrated in FIGS. 11 and 12.

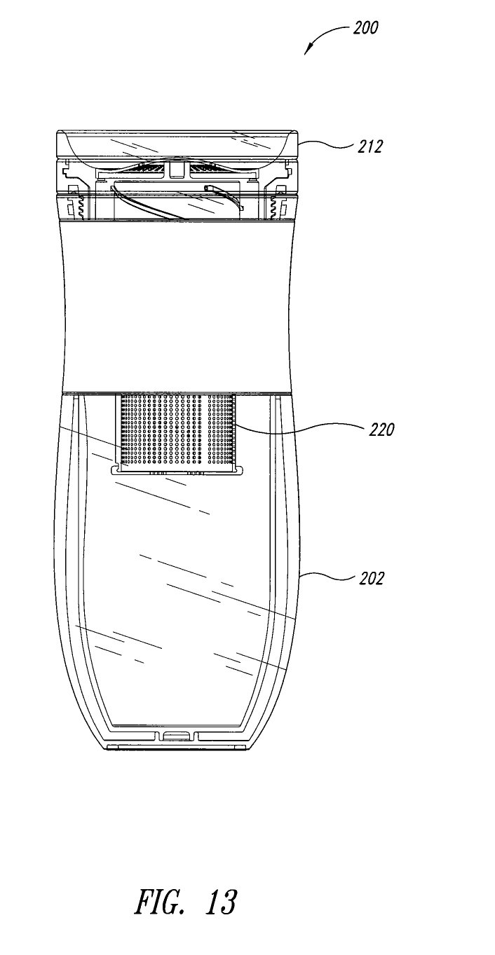

Furthermore, in another embodiment, as illustrated in FIG. 13, an integrated infusion apparatus 200 can include components that are transparent. For example, in the illustrated embodiment of FIG. 13, the beverage container 202 is fabricated from a transparent or translucent material such as glass, polycarbonate and/or polyester or alloys thereof such as those offered under the trademark ClearPC®, and/or any other suitable transparent or translucent material. Furthermore, the actuator 212 or portions thereof can also be transparent in some aspects. In embodiments where the container 202 is transparent the user can view the movement of the infusion element 220.

Therefore, an integrated infusing apparatus or beverage container according to an embodiment of the present disclosure and the claims that follow, allows users to brew or infuse tea or other herbs or infusible products anywhere at any time, without having to dispose the infused tea and without having to remove an infusion assembly or element. Furthermore, since the tea is infused and then moved away from the hot water, as opposed to being pressed, the quality of the tea is improved. Additionally, cleaning of embodiments of the present disclosure or components thereof is easy and not space consuming.

Although some embodiments and aspects have been disclosed, one of ordinary skill in the art will appreciate that modifications can be made to the integrated infusing apparatuses 100, 200, while remaining within the scope of the present disclosure and the claims that follow. For example, the shapes, materials, coupling and sealing features and other features of the components can be varied to suit particular applications, aesthetic appearance and/or any other preference or purpose. In addition, the infusion element may include threads for example on its outer surface, configured to threadedly engage complementary threads on the actuator, such as on the inner surface of the actuator body, to convert movement of the actuator to movement of the infusion element.

Furthermore, submitted herewith are drawings and parts list material for one embodiment. These drawings are provided to illustrate one embodiment and are not intended to limit the scope of the present disclosure in any manner, including size, shape, dimensions and materials of the components. In addition, some embodiments may include additional or fewer components than those illustrated in these or other figures.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An infusing apparatus comprising:
a container having an opening and an interior space elongated about a first axis;
an infusion element having a receptacle including a plurality of perforations, the infusion element configured to be at least partially positioned in the interior space of the container; and
an actuator including an activating member and an actuator body fixedly coupled to the activating member, the activating member being accessible from outside the interior space and movably coupled with respect to the container, the actuator body being movably coupled with respect to the infusion element, movement of the actuator body with respect to the container resulting in movement of the infusion element with respect to the container substantially axially in a direction parallel to the first axis.

2. The infusing apparatus of claim 1 wherein the actuator body includes a threaded region having a plurality of threads, and the infusion element includes, or is fixedly coupled to, a coupling structure configured to slidably engage the threads.

3. The infusing apparatus of claim 1 wherein the actuator body includes an inner surface extending around the first axis, and at least one helical recess circumferentially formed in the inner surface of the actuator body, the infusion element including at least one coupling feature having a protrusion configured to slidably engage the helical recess.

4. The infusing apparatus of claim 1, further comprising:
a coupling ring having an opening and a rim around the opening, the coupling ring being removably coupled to the container and positioned between the opening of the container and the activating member, the activating member being rotatably coupled to the rim, at least a portion of the actuator body extending through the opening and in the interior space of the container.

5. The infusing apparatus of claim 1, further comprising:
at least one alignment member fixedly positioned with respect to the container and having a portion that is positioned adjacent the infusion element and configured to bear against the infusion element to maintain alignment of the infusion element with respect to the actuator body or container.

6. The infusing apparatus of claim 5 wherein the alignment member includes a first end and a second end, opposed to the first end, the first end being fixedly coupled to the coupling ring, the second end being positioned in the interior space adjacent a portion of the infusion element and having at least one protrusion or flange extending toward the infusion element, the protrusion engaging the infusion element to prevent the infusion element from rotating with the activating member.

7. The infusing apparatus of claim 1 wherein the activating member includes a first surface which the first axis intersects, the first surface including a plurality of openings to facilitate dispensing a liquid from the interior space of the container.

8. The infusing apparatus of claim 7, further comprising:
a lid having a plurality of openings and configured to be removably coupled to the activating member toward the first surface of the activating member.

9. The infusing apparatus of claim 1 wherein the receptacle of the infusion element is substantially cylindrical, the infusion element having a rim circumscribing the first axis and having a protrusion extending laterally away from the first axis, the actuator body of the actuator having an inner surface forming a cylindrical hollow and circumscribing the first axis, the inner surface having a first end adjacent the activating member, a second end, axially opposed to the first end, a diameter larger than a diameter of the infusion element, and a helical groove extending from toward the first end to the second end of the inner surface, the protrusion of the infusion element rim being configured to slide along the helical groove to facilitate axial movement of the infusion element in response to rotational movement of the activating member.

10. The infusing apparatus of claim 1 wherein the infusion element includes a first end and a second end, axially opposed to the first end, an infusion cap removably coupled to the receptacle toward the second end, the receptacle being slidably coupled to the actuator body toward the first end of the infusion element.

11. A beverage container adapted for infusing a beverage with tea or herbs, the container comprising:
a body having an interior space terminating at an upper rim and an opposing base;
an infusion assembly coupled to the rim, the infusion assembly comprising an infusion element configured to move toward and away from the base of the body; and
an actuator coupled to the infusion assembly to rotate with respect thereto, rotation of the actuator in a first direction resulting in movement of the infusion element toward the base and rotation of the actuator in an opposite, second direction resulting in movement of the infusion element away from the bases.
